(19) United States
(12) Patent Application Publication
(10) Pub. No.: US 2022/0191385 A1
(43) Pub. Date: Jun. 16, 2022

(54) DYNAMIC CAMERA ADJUSTMENTS IN A ROBOTIC VACUUM CLEANER

(71) Applicant: iRobot Corporation, Bedford, MA (US)

(72) Inventors: Ellen B. Cargill, Norfolk, MA (US); Lihu Chiu, Arcadia, CA (US)

(21) Appl. No.: 17/123,387

(22) Filed: Dec. 16, 2020

(51) Int. Cl. H04N 5/232; G06K 9/00; H04N 7/18; A47L 9/28; A47L 11/40

(52) U.S. Cl. CPC H04N 5/23216; G06K 9/00664; H04N 7/18; A47L 9/2805; A47L 2201/04; A47L 11/4011; A47L 11/4061; A47L 11/4066; A47L 9/2852

(57) ABSTRACT

A method of operating an autonomous mobile cleaning robot using image processing can include producing, using a front-facing camera of the robot, an imaging output based on an optical field of view of the front-facing camera, the imaging output. A first portion of the imaging output and a second portion of the imaging output can be determined. An image capture parameter of the front-facing camera can be adjusted based on the upper portion of the imaging output and the lower portion of the imaging output.

### BACKGROUND

Autonomous mobile robots include autonomous cleaning robots that can autonomously perform cleaning tasks within an environment, such as a home. Many kinds of cleaning robots are autonomous to some degree and in different ways. The autonomy of mobile cleaning robots can be enabled by the use of a controller and multiple sensors mounted on the robot. In some examples, a camera can be included on the robot to capture video in the environment for analysis by the controller to control operation of the mobile cleaning robot within the environment.

### SUMMARY

An optical device, such as a digital camera can be incorporated into a mobile cleaning robot, such as by securing the camera to an outer portion of the mobile cleaning robot in a forward-facing (with respect to a direction of forward travel of the robot) orientation. The camera can provide many helpful features for controlling the robot, such as obstacle detection and avoidance. Because it may be desired to include a camera to improve operation of some aspects of the robot (such as obstacle detection), it may be economical to use the camera for additional functions (such as docking and odometry) to allow for the removal of other sensors from the robot. Using the camera to perform multiple functions requires analysis of different portions of the frame. For example, visual odometry (VO) analysis is often performed using a lower portion of the image and visual simultaneous location and mapping (VSLAM) analysis is often performed using an upper portion of the image stream or frame of the image stream.

However, due to lighting conditions within an environment, luminance (brightness) of the upper portion and lower portion may vary greatly due to natural lighting sources (e.g., sunlight) or artificial lighting sources (e.g., navigational light of the robot), which can make performing analysis for multiple purposes on a single frame very difficult. One solution is to perform analysis for different purposes on different frames and to change exposure between frames. However, changing exposure between frames can cause image flickering and unusable frames as exposure changes can require many or multiple frames to settle.

The devices, systems, and methods of this application can help to address these issues by including a processor configured to divide a frame into multiple regions of interest (ROI) that can be used separately to perform different analyses. For example, a lower ROI can be used for VO and an upper ROI can be used for VSLAM. Luminance for both ROI can be monitored simultaneously, and one ROI can be set to leader and the other to follower, where the leader and follower designations can be changed. The exposure for each ROI can be calculated for each frame regardless of which ROI is a leader and which is a follower. Then, when a leader/follower change is made, the exposure can be set based on the calculations which can help to reduce flickering between frames.

The above discussion is intended to provide an overview of subject matter of the present patent application. It is not intended to provide an exclusive or exhaustive explanation of the invention. The description below is included to provide further information about the present patent application.

### BRIEF DESCRIPTION OF THE DRAWINGS

Various embodiments are illustrated by way of example in the figures of the accompanying drawings. Such embodiments are demonstrative and not intended to be exhaustive or exclusive embodiments of the present subject matter.

FIG. 1 illustrates a plan view of a mobile cleaning robot in an environment.

FIG. 2A illustrates a bottom view of a mobile cleaning robot.

FIG. 2B illustrates an isometric view of a mobile cleaning robot.

FIG. 3 illustrates a cross-section view across indicators 3-3 of FIG. 2A of a mobile cleaning robot.

FIG. 4A illustrates a diagram illustrating an example of a communication network in which a mobile cleaning robot operates and data transmission in the network.

FIG. 4B illustrates a diagram illustrating an exemplary process of exchanging information between the mobile robot and other devices in a communication network.

FIG. 5 illustrates a block diagram of a robot scheduling and controlling system.

FIG. 6A illustrates a frame captured by a camera of a robot.

FIG. 6B illustrates a frame captured by a camera of a robot.

FIG. 6C illustrates a frame captured by a camera of a robot.

FIG. 7A illustrates a frame sequencing table.

FIG. 7B illustrates a frame sequencing table.

FIG. 8A illustrates a flow chart of operating a mobile cleaning robot.

FIG. 8B illustrates a flow chart of operating a mobile cleaning robot.

FIG. 8C illustrates a flow chart of operating a mobile cleaning robot.

FIG. 9A illustrates a flow chart of operating a mobile cleaning robot.

FIG. 9B illustrates a flow chart of operating a mobile cleaning robot.

FIG. 9C illustrates a flow chart of operating a mobile cleaning robot.

### DETAILED DESCRIPTION

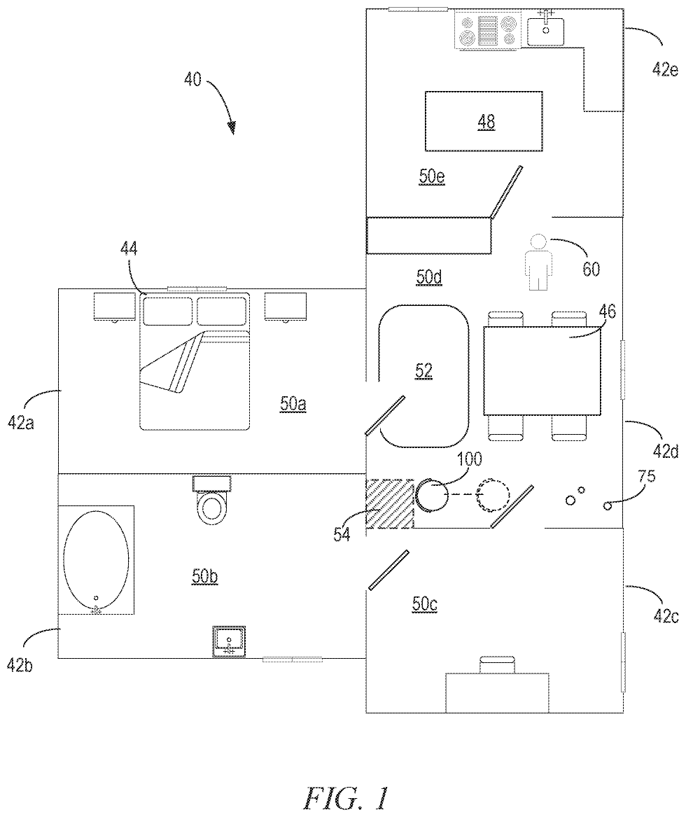

FIG. 1 illustrates a plan view of a mobile cleaning robot 100 in an environment 40, in accordance with at least one example of this disclosure. The environment 40 can be a dwelling, such as a home or an apartment, and can include rooms 42a-42e. Obstacles, such as a bed 44, a table 46, and an island 48 can be located in the rooms 42 of the environment. Each of the rooms 42a-42e can have a floor surface 50a-50e, respectively. Some rooms, such as the room 42d, can include a rug, such as a rug 52. The floor surfaces 50 can be of one or more types such as hardwood, ceramic, low-pile carpet, medium-pile carpet, long (or high)-pile carpet, stone, or the like.

The mobile cleaning robot 100 can be operated, such as by a user 60, to autonomously clean the environment 40 in a room-by-room fashion. In some examples, the robot 100 can clean the floor surface 50a of one room, such as the room 42a, before moving to the next room, such as the room 42d, to clean the surface of the room 42d. Different rooms can have different types of floor surfaces. For example, the room 42e (which can be a kitchen) can have a hard floor surface, such as wood or ceramic tile, and the room 42a (which can be a bedroom) can have a carpet surface, such as a medium pile carpet. Other rooms, such as the room 42d (which can be a dining room) can include multiple surfaces where the rug 52 is located within the room 42d.

During cleaning or traveling operations, the robot 100 can use data collected from various sensors (such as optical sensors) and calculations (such as odometry and obstacle detection) to develop a map of the environment 40. Once the map is created, the user 60 can define rooms or zones (such as the rooms 42) within the map. The map can be presentable to the user 60 on a user interface, such as a mobile device, where the user 60 can direct or change cleaning preferences, for example.

Also, during operation, the robot 100 can detect surface types within each of the rooms 42, which can be stored in the robot or another device. The robot 100 can update the map (or data related thereto) such as to include or account for surface types of the floor surfaces 50a-50e of each of the respective rooms 42 of the environment. In some examples, the map can be updated to show the different surface types such as within each of the rooms 42.

In some examples, the user 60 can define a behavior control zone 54 using, for example, the methods and systems described herein. In response to the user 60 defining the behavior control zone 54, the robot 100 can move toward the behavior control zone 54 to confirm the selection. After confirmation, autonomous operation of the robot 100 can be initiated. In autonomous operation, the robot 100 can initiate a behavior in response to being in or near the behavior control zone 54. For example, the user 60 can define an area of the environment 40 that is prone to becoming dirty to be the behavior control zone 54. In response, the robot 100 can initiate a focused cleaning behavior in which the robot 100 performs a focused cleaning of a portion of the floor surface 50d in the behavior control zone 54.

### Components of the Robot

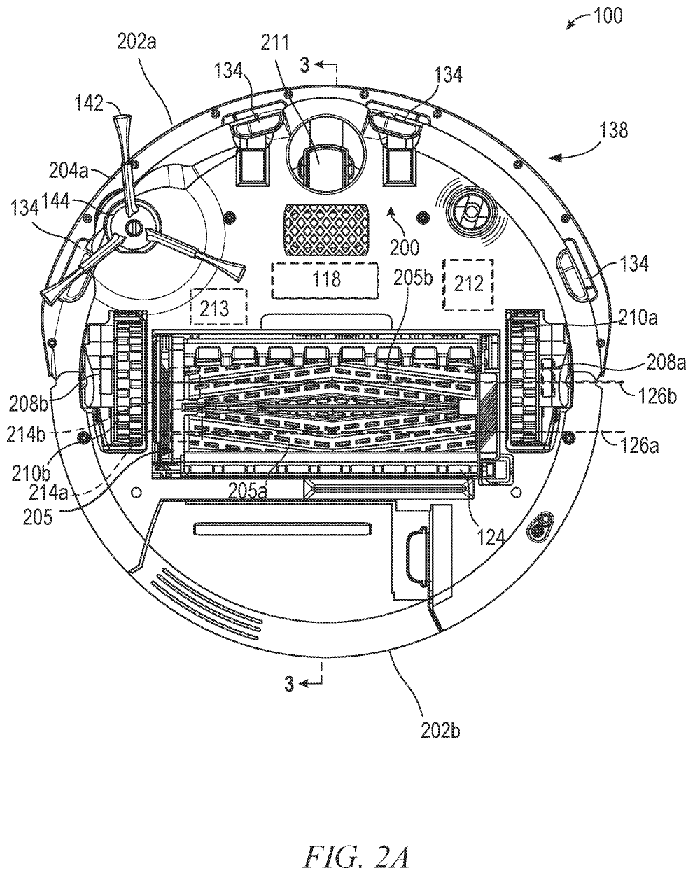

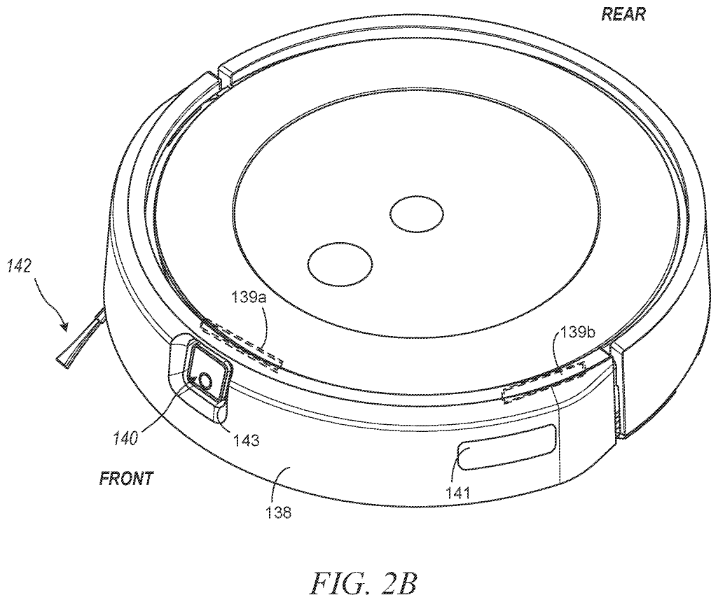

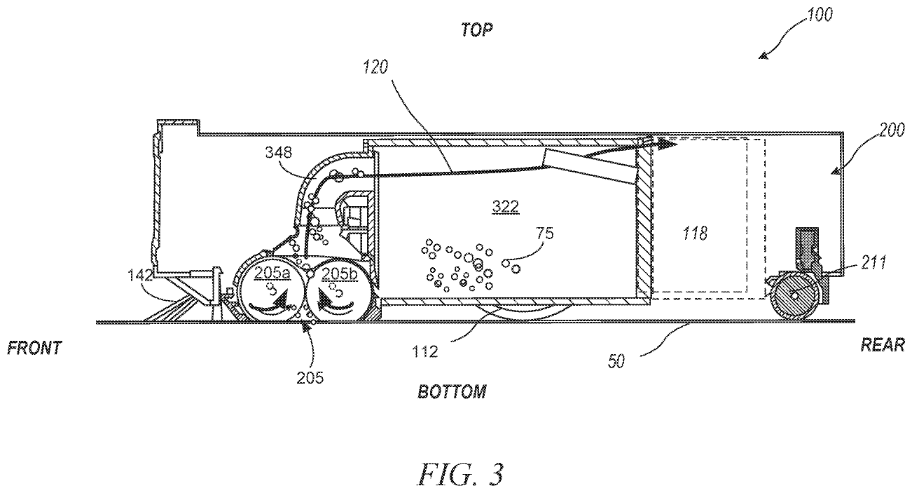

FIG. 2A illustrates a bottom view of the mobile cleaning robot 100. FIG. 2B illustrates a bottom view of the mobile cleaning robot 100. FIG. 3 illustrates a cross-section view across indicators 3-3 of FIG. 2A of the mobile cleaning robot 100. FIG. 3 also shows orientation indicators Bottom, Top, Front, and Rear. FIGS. 2A-3 are discussed together below.

The cleaning robot 100 can be an autonomous cleaning robot that autonomously traverses the floor surface 50 while ingesting the debris 75 from different parts of the floor surface 50. As depicted in FIGS. 2A and 3, the robot 100 includes a body 200 movable across the floor surface 50. The body 200 can include multiple connected structures to which movable components of the cleaning robot 100 are mounted. The connected structures can include, for example, an outer housing to cover internal components of the cleaning robot 100, a chassis to which drive wheels 210a and 210b and the cleaning rollers 205a and 205b (of a cleaning assembly 205) are mounted, a bumper 138 mounted to the outer housing, etc.

As shown in FIG. 2A, the body 200 includes a front portion 202a that has a substantially semicircular shape and a rear portion 202b that has a substantially semicircular shape. As shown in FIG. 2A, the robot 100 can include a drive system including actuators 208a and 208b, e.g., motors, operable with drive wheels 210a and 210b. The actuators 208a and 208b can be mounted in the body 200 and can be operably connected to the drive wheels 210a and 210b, which are rotatably mounted to the body 200. The drive wheels 210a and 210b support the body 200 above the floor surface 50. The actuators 208a and 208b, when driven, can rotate the drive wheels 210a and 210b to enable the robot 100 to autonomously move across the floor surface 50.

The controller (or processor) 212 can be located within the housing and can be a programmable controller, such as a single or multi-board computer, a direct digital controller (DDC), a programmable logic controller (PLC), or the like. In other examples the controller 212 can be any computing device, such as a handheld computer, for example, a smart phone, a tablet, a laptop, a desktop computer, or any other computing device including a processor, memory, and communication capabilities. The memory 213 can be one or more types of memory, such as volatile or non-volatile memory, read-only memory (ROM), random-access memory (RAM), magnetic disk storage media, optical storage media, flash-memory devices, and other storage devices and media. The memory 213 can be located within the housing 200, connected to the controller 212 and accessible by the controller 212.

The controller 212 can operate the actuators 208a and 208b to autonomously navigate the robot 100 about the floor surface 50 during a cleaning operation. The actuators 208a and 208b are operable to drive the robot 100 in a forward drive direction, in a backwards direction, and to turn the robot 100. The robot 100 can include a caster wheel 211 that supports the body 200 above the floor surface 50. The caster wheel 211 can support the rear portion 202b of the body 200 above the floor surface 50, and the drive wheels 210a and 210b support the front portion 202a of the body 200 above the floor surface 50.

As shown in FIG. 3, a vacuum assembly 118 can be carried within the body 200 of the robot 100, e.g., in the front portion 202a of the body 200. The controller 212 can operate the vacuum assembly 118 to generate an airflow that flows through the air gap near the cleaning rollers 205, through the body 200, and out of the body 200. The vacuum assembly 118 can include, for example, an impeller that generates the airflow when rotated. The airflow and the cleaning rollers 205, when rotated, cooperate to ingest debris 75 into the robot 100. A cleaning bin 322 mounted in the body 200 contains the debris 75 ingested by the robot 100, and a filter in the body 200 separates the debris 75 from the airflow before the airflow 120 enters the vacuum assembly 118 and is exhausted out of the body 200. In this regard, the debris 75 is captured in both the cleaning bin 322 and the filter before the airflow 120 is exhausted from the body 200.

The cleaning rollers 205a and 205b can operably connected to actuators 214a and 214b, e.g., motors, respectively. The cleaning head 205 and the cleaning rollers 205a and 205b can positioned forward of the cleaning bin 322. The cleaning rollers 205a and 205b can be mounted to a housing 124 of the cleaning head 205 and mounted, e.g., indirectly or directly, to the body 200 of the robot 100. In particular, the cleaning rollers 205a and 205b are mounted to an underside of the body 200 so that the cleaning rollers 205a and 205b engage debris 75 on the floor surface 50 during the cleaning operation when the underside faces the floor surface 50.

The housing 124 of the cleaning head 205 can be mounted to the body 200 of the robot 100. In this regard, the cleaning rollers 205a and 205b are also mounted to the body 200 of the robot 100, e.g., indirectly mounted to the body 200 through the housing 124. Alternatively, or additionally, the cleaning head 205 is a removable assembly of the robot 100 in which the housing 124 with the cleaning rollers 205a and 205b mounted therein is removably mounted to the body 200 of the robot 100. The housing 124 and the cleaning rollers 205a and 205b are removable from the body 200 as a unit so that the cleaning head 205 is easily interchangeable with a replacement cleaning head 205.

The control system can further include a sensor system with one or more electrical sensors. The sensor system, as described herein, can generate a signal indicative of a current location of the robot 100, and can generate signals indicative of locations of the robot 100 as the robot 100 travels along the floor surface 50.

Cliff sensors 134 (shown in FIG. 2A) can be located along a bottom portion of the housing 200. Each of the cliff sensors 134 can be an optical sensor that can be configured to detect a presence or absence of an object below the optical sensor, such as the floor surface 50. The cliff sensors 134 can be connected to the controller 212. A bumper 138 can be removably secured to the body 200 and can be movable relative to body 200 while mounted thereto. In some examples, the bumper 138 form part of the body 200. The bump sensors 139a and 139b (the bump sensors 139) can be connected to the body 200 and engageable or configured to interact with the bumper 138. The bump sensors 139 can include break beam sensors, capacitive sensors, switches, or other sensors that can detect contact between the robot 100, i.e., the bumper 138, and objects in the environment 40. The bump sensors 139 can be in communication with the controller 212.

An image capture device 140 can be a camera connected to the body 200 and can extend through the bumper 138 of the robot 100, such as through an opening 143 of the bumper 138. The image capture device 140 can be a camera, such as a front-facing camera, configured to generate a signal based on imagery of the environment 40 of the robot 100 as the robot 100 moves about the floor surface 50. The image capture device 140 can transmit the signal to the controller 212 for use for navigation and cleaning routines.

Obstacle following sensors 141 (shown in FIG. 2B) can include an optical sensor facing outward from the bumper 138 and that can be configured to detect the presence or the absence of an object adjacent to a side of the body 200. The obstacle following sensor 141 can emit an optical beam horizontally in a direction perpendicular (or nearly perpendicular) to the forward drive direction of the robot 100. The optical emitter can emit an optical beam outward from the robot 100, e.g., outward in a horizontal direction, and the optical detector detects a reflection of the optical beam that reflects off an object near the robot 100. The robot 100, e.g., using the controller 212, can determine a time of flight of the optical beam and thereby determine a distance between the optical detector and the object, and hence a distance between the robot 100 and the object.

A side brush 142 can be connected to an underside of the robot 100 and can be connected to a motor 144 operable to rotate the side brush 142 with respect to the body 200 of the robot 100. The side brush 142 can be configured to engage debris to move the debris toward the cleaning assembly 205 or away from edges of the environment 40. The motor 144 configured to drive the side brush 142 can be in communication with the controller 112. The brush 142 can rotate about a non-horizontal axis, e.g., an axis forming an angle between 75 degrees and 90 degrees with the floor surface 50. The non-horizontal axis, for example, can form an angle between 75 degrees and 90 degrees with the longitudinal axes 126a and 126b of the rollers 205a and 205b.

The brush 142 can be a side brush laterally offset from a center of the robot 100 such that the brush 142 can extend beyond an outer perimeter of the body 200 of the robot 100. Similarly, the brush 142 can also be forwardly offset of a center of the robot 100 such that the brush 142 also extends beyond the bumper 138.

### Operation of the Robot

In operation of some examples, the robot 100 can be propelled in a forward drive direction or a rearward drive direction. The robot 100 can also be propelled such that the robot 100 turns in place or turns while moving in the forward drive direction or the rearward drive direction.

When the controller 212 causes the robot 100 to perform a mission, the controller 212 can operate the motors 208 to drive the drive wheels 210 and propel the robot 100 along the floor surface 50. In addition, the controller 212 can operate the motors 214 to cause the rollers 205a and 205b to rotate, can operate the motor 144 to cause the brush 142 to rotate, and can operate the motor of the vacuum system 118 to generate airflow. The controller 212 can execute software stored on the memory 213 to cause the robot 100 to perform various navigational and cleaning behaviors by operating the various motors of the robot 100.

The various sensors of the robot 100 can be used to help the robot navigate and clean within the environment 40. For example, the cliff sensors 134 can detect obstacles such as drop-offs and cliffs below portions of the robot 100 where the cliff sensors 134 are disposed. The cliff sensors 134 can transmit signals to the controller 212 so that the controller 212 can redirect the robot 100 based on signals from the cliff sensors 134.

In some examples, a bump sensor 139a can be used to detect movement of the bumper 138 along a fore-aft axis of the robot 100. A bump sensor 139b can also be used to detect movement of the bumper 138 along one or more sides of the robot 100. The bump sensors 139 can transmit signals to the controller 212 so that the controller 212 can redirect the robot 100 based on signals from the bump sensors 139.

The image capture device 140 can be configured to generate a signal based on imagery of the environment 40 of the robot 100 as the robot 100 moves about the floor surface 50. The image capture device 140 can transmit such a signal to the controller 212. The image capture device 140 can be angled in an upward direction, e.g., angled between 5 degrees and 45 degrees from the floor surface 50 about which the robot 100 navigates. The image capture device 140, when angled upward, can capture images of wall surfaces of the environment so that features corresponding to objects on the wall surfaces can be used for localization.

In some examples, the obstacle following sensors 141 can detect detectable objects, including obstacles such as furniture, walls, persons, and other objects in the environment of the robot 100. In some implementations, the sensor system can include an obstacle following sensor along a side surface, and the obstacle following sensor can detect the presence or the absence an object adjacent to the side surface. The one or more obstacle following sensors 141 can also serve as obstacle detection sensors, similar to the proximity sensors described herein.

The robot 100 can also include sensors for tracking a distance travelled by the robot 100. For example, the sensor system can include encoders associated with the motors 208 for the drive wheels 210, and the encoders can track a distance that the robot 100 has travelled. In some implementations, the sensor can include an optical sensor facing downward toward a floor surface. The optical sensor can be positioned to direct light through a bottom surface of the robot 100 toward the floor surface 50. The optical sensor can detect reflections of the light and can detect a distance travelled by the robot 100 based on changes in floor features as the robot 100 travels along the floor surface 50.

The controller 212 can use data collected by the sensors of the sensor system to control navigational behaviors of the robot 100 during the mission. For example, the controller 212 can use the sensor data collected by obstacle detection sensors of the robot 100, (the cliff sensors 134, the bump sensors 139, and the image capture device 140) to enable the robot 100 to avoid obstacles within the environment of the robot 100 during the mission.

The sensor data can also be used by the controller 212 for simultaneous localization and mapping (SLAM) techniques in which the controller 212 extracts features of the environment represented by the sensor data and constructs a map of the floor surface 50 of the environment. The sensor data collected by the image capture device 140 can be used for techniques such as vision-based SLAM (VSLAM) in which the controller 212 extracts visual features corresponding to objects in the environment 40 and constructs the map using these visual features. As the controller 212 directs the robot 100 about the floor surface 50 during the mission, the controller 212 can use SLAM techniques to determine a location of the robot 100 within the map by detecting features represented in collected sensor data and comparing the features to previously stored features. The map formed from the sensor data can indicate locations of traversable and non-traversable space within the environment. For example, locations of obstacles can be indicated on the map as non-traversable space, and locations of open floor space can be indicated on the map as traversable space.

The sensor data collected by any of the sensors can be stored in the memory 213. In addition, other data generated for the SLAM techniques, including mapping data forming the map, can be stored in the memory 213. These data produced during the mission can include persistent data that are produced during the mission and that are usable during further missions. In addition to storing the software for causing the robot 100 to perform its behaviors, the memory 213 can store data resulting from processing of the sensor data for access by the controller 212. For example, the map can be a map that is usable and updateable by the controller 212 of the robot 100 from one mission to another mission to navigate the robot 100 about the floor surface 50.

The persistent data, including the persistent map, helps to enable the robot 100 to efficiently clean the floor surface 50. For example, the map enables the controller 212 to direct the robot 100 toward open floor space and to avoid non-traversable space. In addition, for subsequent missions, the controller 212 can use the map to optimize paths taken during the missions to help plan navigation of the robot 100 through the environment 40.

### Network Examples

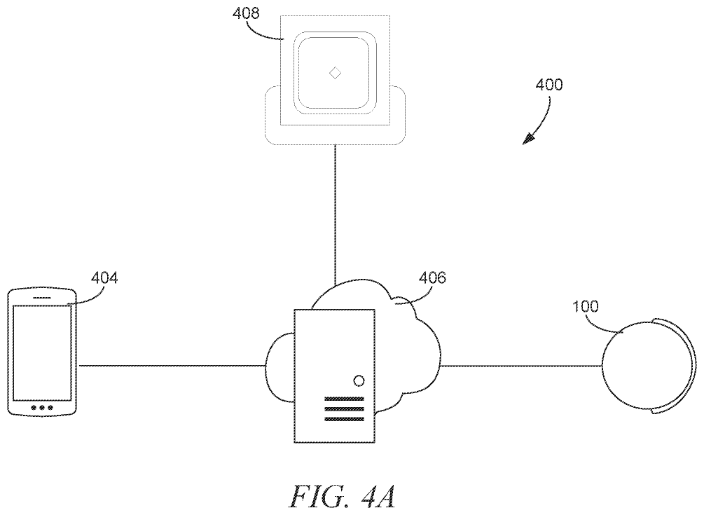

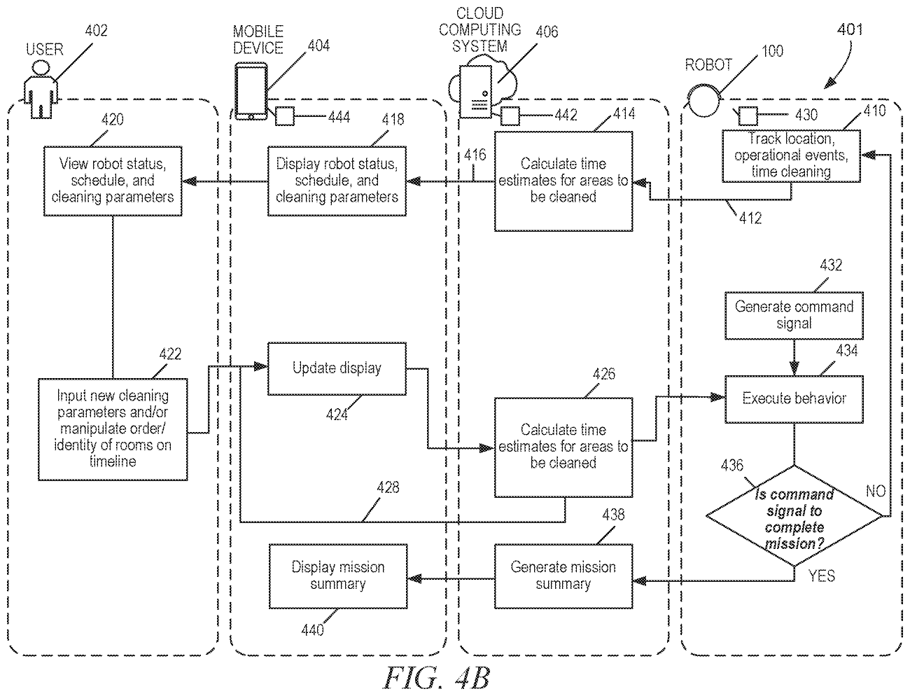

FIG. 4A is a diagram illustrating by way of example and not limitation a communication network 400 that enables networking between the mobile robot 100 and one or more other devices, such as a mobile device 404, a cloud computing system 406, or another autonomous robot 408 separate from the mobile robot 404. Using the communication network 410, the robot 100, the mobile device 404, the robot 408, and the cloud computing system 406 can communicate with one another to transmit and receive data from one another. In some examples, the robot 100, the robot 408, or both the robot 100 and the robot 408 communicate with the mobile device 404 through the cloud computing system 406. Alternatively, or additionally, the robot 100, the robot 408, or both the robot 100 and the robot 408 communicate directly with the mobile device 404. Various types and combinations of wireless networks (e.g., Bluetooth, radio frequency, optical based, etc.) and network architectures (e.g., mesh networks) can be employed by the communication network 410.

In some examples, the mobile device 404 can be a remote device that can be linked to the cloud computing system 406 and can enable a user to provide inputs. The mobile device 404 can include user input elements such as, for example, one or more of a touchscreen display, buttons, a microphone, a mouse, a keyboard, or other devices that respond to inputs provided by the user. The mobile device 404 can also include immersive media (e.g., virtual reality) with which the user can interact to provide input. The mobile device 404, in these examples, can be a virtual reality headset or a head-mounted display.

The user can provide inputs corresponding to commands for the mobile robot 404. In such cases, the mobile device 404 can transmit a signal to the cloud computing system 406 to cause the cloud computing system 406 to transmit a command signal to the mobile robot 100. In some implementations, the mobile device 404 can present augmented reality images. In some implementations, the mobile device 404 can be a smart phone, a laptop computer, a tablet computing device, or other mobile device.

According to some examples discussed herein, the mobile device 404 can include a user interface configured to display a map of the robot environment. A robot path, such as that identified by a coverage planner, can also be displayed on the map. The interface can receive a user instruction to modify the environment map, such as by adding, removing, or otherwise modifying a keep-out zone in the environment: adding, removing, or otherwise modifying a focused cleaning zone in the environment (such as an area that requires repeated cleaning); restricting a robot traversal direction or traversal pattern in a portion of the environment; or adding or changing a cleaning rank, among others.

In some examples, the communication network 410 can include additional nodes. For example, nodes of the communication network 410 can include additional robots. Also, nodes of the communication network 410 can include network-connected devices that can generate information about the environment 40. Such a network-connected device can include one or more sensors, such as an acoustic sensor, an image capture system, or other sensor generating signals, to detect characteristics of the environment 40 from which features can be extracted. Network-connected devices can also include home cameras, smart sensors, or the like.

In the communication network 410, the wireless links can utilize various communication schemes, protocols, etc., such as, for example, Bluetooth classes, Wi-Fi, Bluetooth-low-energy, also known as BLE, 802.15.4, Worldwide Interoperability for Microwave Access (WiMAX), an infrared channel, satellite band, or the like. In some examples, wireless links can include any cellular network standards used to communicate among mobile devices, including, but not limited to, standards that qualify as 1G, 2G, 3G, 4G, 5G, or the like. The network standards, if utilized, qualify as, for example, one or more generations of mobile telecommunication standards by fulfilling a specification or standards such as the specifications maintained by International Telecommunication Union. For example, the 4G standards can correspond to the International Mobile Telecommunications Advanced (IMT-Advanced) specification. Examples of cellular network standards include AMPS, GSM, GPRS, UMTS, LTE, LTE Advanced, Mobile WiMAX, and WiMAX-Advanced. Cellular network standards can use various channel access methods, e.g., FDMA, TDMA, CDMA, or SDMA.

FIG. 4B is a diagram illustrating an exemplary process 401 of exchanging information among devices in the communication network 410, including the mobile robot 100, the cloud computing system 406, and the mobile device 404.

In operation of some examples, a cleaning mission can be initiated by pressing a button on the mobile robot 100 (or the mobile device 404) or can be scheduled for a future time or day. The user can select a set of rooms to be cleaned during the cleaning mission or can instruct the robot to clean all rooms. The user can also select a set of cleaning parameters to be used in each room during the cleaning mission.

During a cleaning mission, the mobile robot 100 can track 410 its status, including its location, any operational events occurring during cleaning, and time spent cleaning. The mobile robot 100 can transmit 412 status data (e.g. one or more of location data, operational event data, time data) to the cloud computing system 406, which can calculate 414, such as by a processor 442, time estimates for areas to be cleaned. For example, a time estimate can be calculated for cleaning a room by averaging the actual cleaning times for the room that have been gathered during one or more prior cleaning mission(s) of the room. The cloud computing system 406 can transmit 416 time estimate data along with robot status data to the mobile device 404. The mobile device 404 can present 418, such as by a processor 444, the robot status data and time estimate data on a display. The robot status data and time estimate data can be presented on the display of the mobile device 404 as any of a number of graphical representations editable mission timeline or a mapping interface.

A user 402 can view 420 the robot status data and time estimate data on the display and can input 422 new cleaning parameters or can manipulate the order or identity of rooms to be cleaned. The user 402 can also delete rooms from a cleaning schedule of the mobile robot 100. In other instances, the user 402 can select an edge cleaning mode or a deep cleaning mode for a room to be cleaned.

The display of the mobile device 404 can be updated 424 as the user changes the cleaning parameters or cleaning schedule. For example, if the user changes the cleaning parameters from single pass cleaning to dual pass cleaning, the system will update the estimated time to provide an estimate based on the new parameters. In this example of single pass cleaning vs. dual pass cleaning, the estimate would be approximately doubled. In another example, if the user removes a room from the cleaning schedule, the total time estimate is decreased by approximately the time needed to clean the removed room. Based on the inputs from the user 402, the cloud computing system 406 can calculate 426 time estimates for areas to be cleaned, which can then be transmitted 428 (e.g. by a wireless transmission, by applying a protocol, by broadcasting a wireless transmission) back to the mobile device 404 and displayed. Additionally, data relating to the calculated time 426 estimates can be transmitted 446 to a controller 430 of the robot. Based on the inputs from the user 402, which are received by the controller 430 of the mobile robot 100, the controller 430 can generate 432 a command signal. The command signal commands the mobile robot 100 to execute 434 a behavior, such as a cleaning behavior. As the cleaning behavior is executed, the controller 430 can continue to track 410 a status of the robot 100, including its location, any operational events occurring during cleaning, or a time spent cleaning. In some instances, live updates relating to a status of the robot 100 can be additionally provided via push notifications to the mobile device 404 or a home electronic system (e.g. an interactive speaker system).

Upon executing a behavior 434, the controller 430 can check 436 to see if the received command signal includes a command to complete the cleaning mission. If the command signal includes a command to complete the cleaning mission, the robot can be commanded to return to its dock and upon return can transmit information to enable the cloud computing system 406 to generate 438 a mission summary which can be transmitted to, and displayed 440 by, the mobile device 404. The mission summary can include a timeline or a map. The timeline can display, the rooms cleaned, a time spent cleaning each room, operational events tracked in each room, etc. The map can display the rooms cleaned, operational events tracked in each room, a type of cleaning (e.g. sweeping or mopping) performed in each room, etc.

In some examples, communications can occur between the mobile robot 100 and the mobile device 404 directly. For example, the mobile device 404 can be used to transmit one or more instructions through a wireless method of communication, such as Bluetooth or Wi-fi, to instruct the mobile robot 100 to perform a cleaning operation (mission).

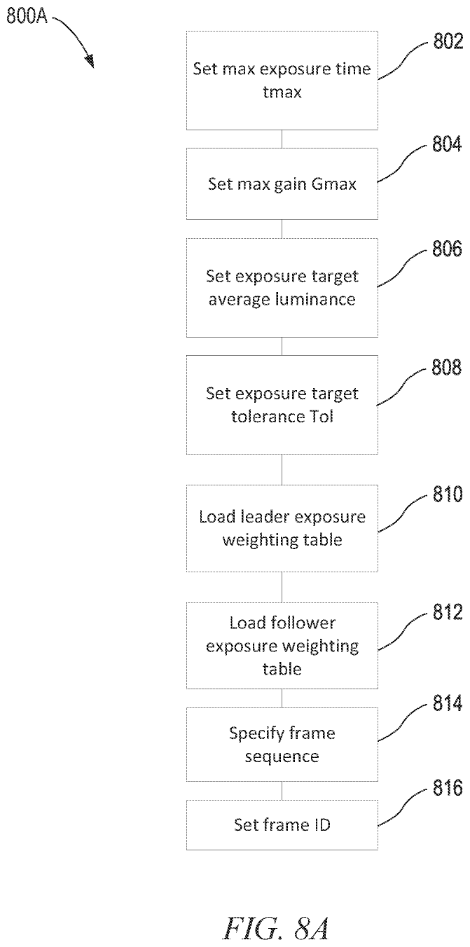

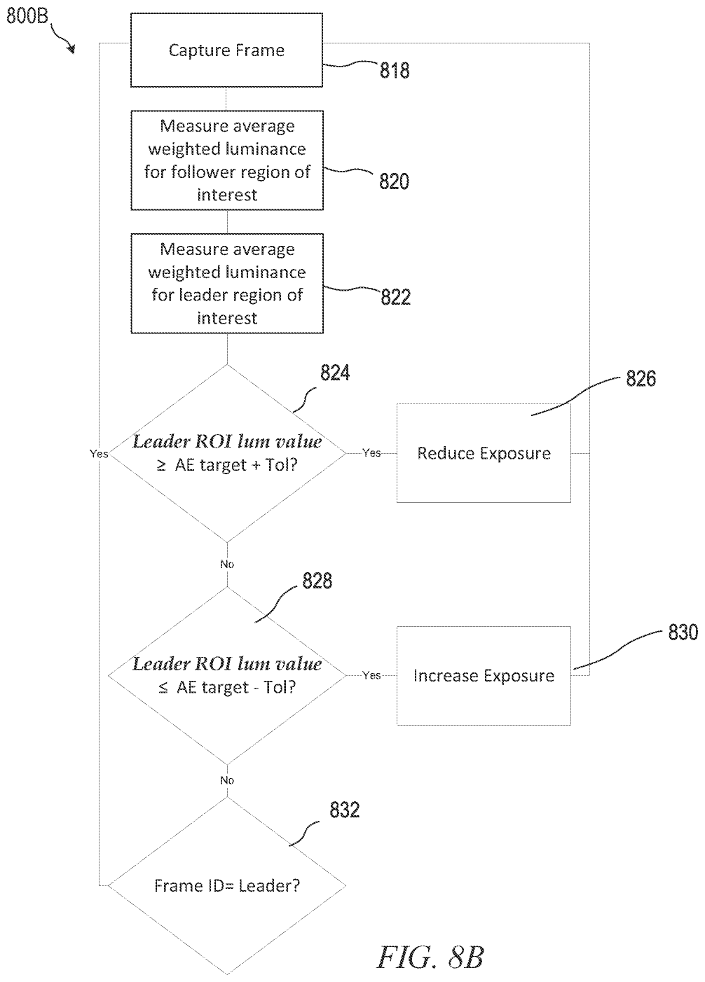

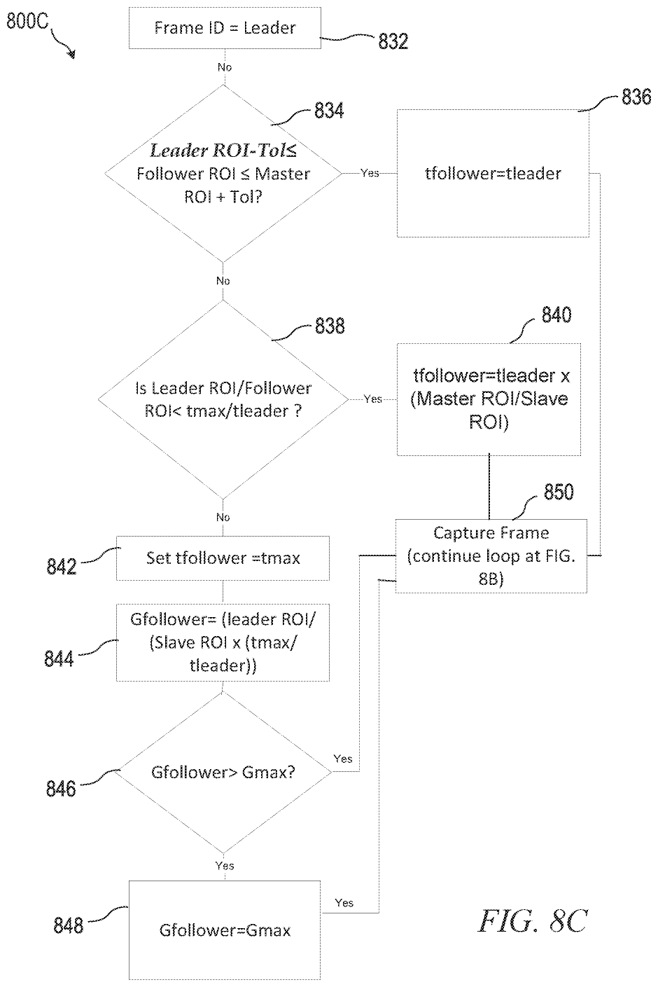

Operations for the process 401 and other processes described herein, such one or more steps discussed with respect to FIGS. 8A-10C can be executed in a distributed manner. For example, the cloud computing system 406, the mobile robot 100, and the mobile device 404 can execute one or more of the operations in concert with one another. Operations described as executed by one of the cloud computing system 406, the mobile robot 100, and the mobile device 404 are, in some implementations, executed at least in part by two or all of the cloud computing system 406, the mobile robot 100, and the mobile device 404.

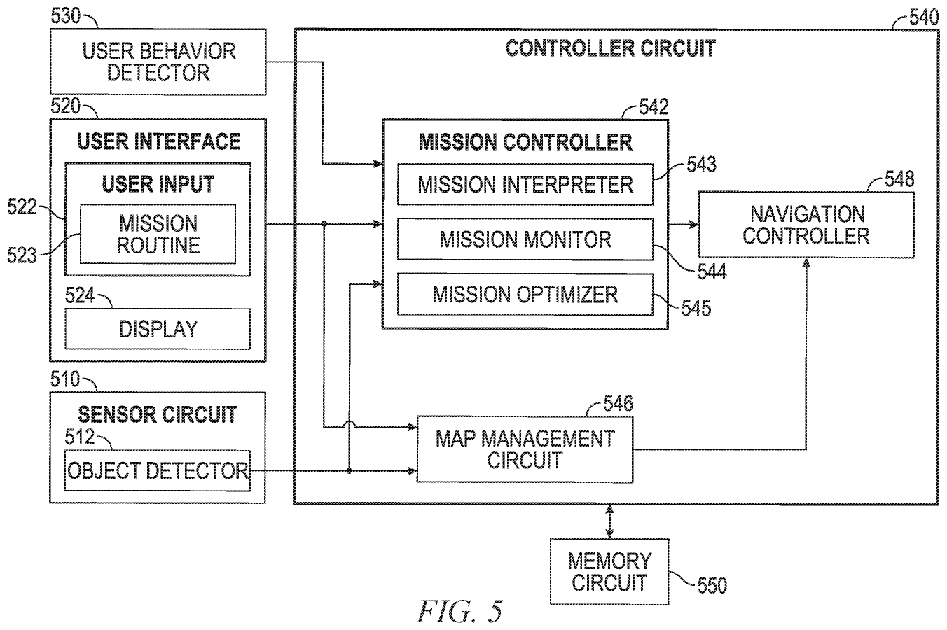

FIG. 5 is a diagram of a robot scheduling and controlling system 500 configured to generate and manage a mission routine for a mobile robot (e.g., the mobile robot 100), and control the mobile robot to execute the mission in accordance with the mission routine. The robot scheduling and controlling system 500, and methods of using the same, as described herein in accordance with various embodiments, can be used to control one or more mobile robots of various types, such as a mobile cleaning robot, a mobile mopping robot, a lawn mowing robot, or a space-monitoring robot.

The system 500 can include a sensor circuit 510, a user interface 520, a user behavior detector 530, a controller circuit 540, and a memory circuit 550. The system 500 can be implemented in one or more of the mobile robot 100, the mobile device 404, the autonomous robot 408, or the cloud computing system 406. In an example, some or all of the system 500 can be implemented in the mobile robot 100. Some or all of the system 500 can be implemented in a device separate from the mobile robot 100, such as a mobile device 404 (e.g., a smart phone or other mobile computing devices) communicatively coupled to the mobile robot 100. For example, the sensor circuit 510 and at least a portion of the user behavior detector 530 can be included the mobile robot 100. The user interface 520, the controller circuit 540, and the memory circuit 550 can be implemented in the mobile device 404. The controller circuit 540 can execute computer-readable instructions (e.g., a mobile application, or “app”) to perform mission scheduling and generating instructions for controlling the mobile robot 100. The mobile device 404 can be communicatively coupled to the mobile robot 100 via an intermediate system such as the cloud computing system 406, as illustrated in FIGS. 4A and 4B. Alternatively, the mobile device 404 can communication with the mobile robot 100 via a direct communication link without an intermediate device of system.

The sensor circuit 510 can include one or more sensors including, for example, optical sensors, cliff sensors, proximity sensors, bump sensors, imaging sensor (e.g., camera), or obstacle detection sensors, among other sensors such as discussed above with reference to FIGS. 2A-2B and 3. Some of the sensors can sense obstacles (e.g., occupied regions such as walls) and pathways and other open spaces within the environment. The sensor circuit 510 can include an object detector 512 configured to detect an object in a robot environment, and recognize it as, for example, a door, or a clutter, a wall, a divider, a furniture (such as a table, a chair, a sofa, a couch, a bed, a desk, a dresser, a cupboard, a bookcase, etc.), or a furnishing element (e.g., appliances, rugs, curtains, paintings, drapes, lamps, cooking utensils, built-in ovens, ranges, dishwashers, etc.), among others.

The sensor circuit 510 can detect spatial, contextual, or other semantic information for the detected object. Examples of semantic information can include identity, location, physical attributes, or a state of the detected object, spatial relationship with other objects, among other characteristics of the detected object. For example, for a detected table, the sensor circuit 510 can identify a room or an area in the environment that accommodates the table (e.g., a kitchen). The spatial, contextual, or other semantic information can be associated with the object to create a semantic object (e.g., a kitchen table), which can be used to create an object-based cleaning mission routine, as to be discussed in the following.

The user interface 520, which can be implemented in a handheld computing device such as the mobile device 404, includes a user input 522 and a display 524. A user can use the user input 522 to create a mission routine 523. The mission routine 523 can include data representing an editable schedule for at least one mobile robot to performing one or more tasks. The editable schedule can include time or order for performing the cleaning tasks. In an example, the editable schedule can be represented by a timeline of tasks. The editable schedule can optionally include time estimates to complete the mission, or time estimates to complete a particular task in the mission. The user interface 520 can include user interface controls that enable a user to create or modify the mission routine 523. In some examples, the user input 522 can be configured to receive a user's voice command for creating or modifying a mission routine. The handheld computing device can include a speech recognition and dictation module to translate the user's voice command to device-readable instructions which are taken by the controller circuit 540 to create or modify a mission routine.

The display 524 can present information about the mission routine 523, progress of a mission routine that is being executed, information about robots in a home and their operating status, and a map with semantically annotated objects, among other information. The display 524 can also display user interface controls that allow a user to manipulate the display of information, schedule and manage mission routines, and control the robot to execute a mission. Examples of the user interface 520 are discussed below.

The controller circuit 540, which is an example of the controller 212, can interpret the mission routine 523 such as provided by a user via the user interface 520, and control at least one mobile robot to execute a mission in accordance with the mission routine 523. The controller circuit 540 can create and maintain a map including semantically annotated objects, and use such a map to schedule a mission and navigate the robot about the environment. In an example, the controller circuit 540 can be included in a handheld computing device, such as the mobile device 404. Alternatively, the controller circuit 540 can be at least partially included in a mobile robot, such as the mobile robot 100. The controller circuit 540 can be implemented as a part of a microprocessor circuit, which can be a dedicated processor such as a digital signal processor, application specific integrated circuit (ASIC), microprocessor, or other type of processor for processing information including physical activity information. Alternatively, the microprocessor circuit can be a processor that can receive and execute a set of instructions of performing the functions, methods, or techniques described herein.

The controller circuit 540 can include circuit sets comprising one or more other circuits or sub-circuits, such as a mission controller 542, a map management circuit 546, and a navigation controller 548. These circuits or modules can, alone or in combination, perform the functions, methods, or techniques described herein. In an example, hardware of the circuit set can be immutably designed to carry out a specific operation (e.g., hardwired). In an example, the hardware of the circuit set can include variably connected physical components (e.g., execution units, transistors, simple circuits, etc.) including a computer readable medium physically modified (e.g., magnetically, electrically, moveable placement of invariant massed particles, etc.) to encode instructions of the specific operation. In connecting the physical components, the underlying electrical properties of a hardware constituent are changed, for example, from an insulator to a conductor or vice versa. The instructions enable embedded hardware (e.g., the execution units or a loading mechanism) to create members of the circuit set in hardware via the variable connections to carry out portions of the specific operation when in operation. Accordingly, the computer readable medium is communicatively coupled to the other components of the circuit set member when the device is operating. In an example, any of the physical components can be used in more than one member of more than one circuit set. For example, under operation, execution units can be used in a first circuit of a first circuit set at one point in time and reused by a second circuit in the first circuit set, or by a third circuit in a second circuit set at a different time.

The mission controller 542 can receive the mission routine 523 from the user interface 520. As discussed above, the mission routine 523 includes data representing an editable schedule, including at least one of time or order, for performing one or more tasks. In some examples, the mission routine 523 can represent a personalized mode of executing a mission routine. For a mobile cleaning robot, examples of a personalized cleaning mode can include a “standard clean”, a “deep clean”, a “quick clean”, a “spot clean”, or an “edge and corner clean”. Each of these mission routines defines respective rooms or floor surface areas to be cleaned and an associated cleaning pattern.

The mission routine 523, such as a personalized cleaning mode (e.g., a deep clean mode), can include one or more tasks characterized by respective spatial or contextual information of an object in the environment, or one or more tasks characterized by a user's experience such as the use's behaviors or routine activities in association with the use of a room or an area in the environment. The mission controller 542 can include a mission interpreter 543 to extract from the mission routine 523 information about a location for the mission (e.g., rooms or area to be clean with respect to an object detected in the environment), time and/or order for executing the mission with respect to user experience, or a manner of cleaning the identified room or area. The mission monitor 544 can monitor the progress of a mission. In an example, the mission monitor 544 can generate a mission status report showing the completed tasks (e.g., rooms that have cleaned) and tasks remaining to be performed (e.g., rooms to be cleaned according to the mission routine). The mission optimizer 545 can pause, abort, or modify a mission routine or a task therein such in response to a user input or a trigger event. The mission modification can be carried out during the execution of the mission routine.

In some examples, the mission optimizer 545 can receive a time allocation for completing a mission, and prioritize one or more tasks in the mission routine based on the time allocation. To execute a user experience-based mission routine or task such as “clean as many rooms as possible within next hour”, the mission monitor 544 can estimate time for completing individual tasks in the mission (e.g., time required for cleaning individual rooms), such as based on room size, room dirtiness level, or historical mission or task completion time. The optimizer 545 can modify the mission routine by identifying and prioritizing those tasks that can be completed within the allocated time.

The map management circuit 546 can generate and maintain a map of the environment or a portion thereof. In an example, the map management circuit 546 can generate a semantically annotated object by associating an object, such as detected by the object detector 512, with semantic information, such as spatial or contextual information. Examples of the semantic information can include location, an identity, or a state of an object in the environment, or constraints of spatial relationship between objects, among other object or inter-object characteristics. The semantically annotated object can be graphically displayed on the map, thereby creating a semantic map. The semantic map can be used for mission control by the mission controller 542, or for robot navigation control by the navigation controller 548. The semantic map can be stored in the memory circuit 550.

In some examples, the map management circuit 546 can determine that the detected object indicates that the map requires an update. For example, the map management circuit 546 can associate the detected object with a behavior to apply a keep out zone to the map. The map management circuit 546 can then update the map to allow the navigation controller 548 to avoid the keep out zone during its mission and in future missions.

Semantic annotations can be added for an object algorithmically. In an example, the map management circuit 546 can employ SLAM techniques to detect, classify, or identify an object, determine a state or other characteristics of an object using sensor data (e.g., image data, infrared sensor data, or the like). Other techniques for feature extraction and object identification can be used, such as geometry algorithms, heuristics, or machine learning algorithms to infer semantics from the sensor data. For example, the map management circuit 546 can apply image detection or classification algorithms to recognize an object of a particular type, or analyze the images of the object to determine a state of the object (e.g., a door being open or closed, or locked or unlocked). Alternatively or additionally, semantic annotations can be added by a user via the user interface 520. Identification, attributes, state, among other characteristics and constraints, can be manually added to the semantic map and associated with an object by a user.

The navigation controller 548 can navigate the mobile robot to conduct a mission in accordance with the mission routine. In an example, the mission routine can include a sequence of rooms or floor surface areas to be cleaned by a mobile cleaning robot. The mobile cleaning robots can have a vacuum assembly (such as the vacuum assembly 118) and can use suction to ingest debris as the mobile cleaning robot (such as the robot 100) traverses the floor surface (such as the surface 50). In another example, the mission routine can include a sequence of rooms or floor surface areas to be mopped by a mobile mopping robot. The mobile mopping robot can have a cleaning pad for wiping or scrubbing the floor surface. In some examples, the mission routine can include tasks scheduled to be executed by two mobile robots sequentially, intertwined, in parallel, or in another specified order or pattern. For example, the navigation controller 548 can navigate a mobile cleaning robot to vacuum a room, and navigate a mobile mopping robot to mop the room that has been vacuumed.

In an example, the mission routine can include one or more cleaning tasks characterized by, or made reference to, spatial or contextual information of an object in the environment, such as detected by the object detector 512. In contrast to a room-based cleaning mission that specifies a particular room or area (e.g., as shown on a map) to be cleaned by the mobile cleaning robot, an object-based mission can include a task that associates an area to be cleaned with an object in that area, such as “clean under the dining table”, “clean along the kickboard in the kitchen”, “clean near the kitchen stove”, “clean under the living room couch”, or “clean the cabinets area of the kitchen sink”, etc. As discussed above with reference to FIG. 5, the sensor circuit 510 can detect the object in the environment and the spatial and contextual information association with the object. The controller circuit 540 can create a semantically annotated object by establishing an association between the detected object and the spatial or contextual information, such as using a map created and stored in the memory circuit 550. The mission interpreter 543 can interpret the mission routine to determine the target cleaning area with respect to the detected object, and navigate the mobile cleaning robot to conduct the cleaning mission.

### Camera Control Examples

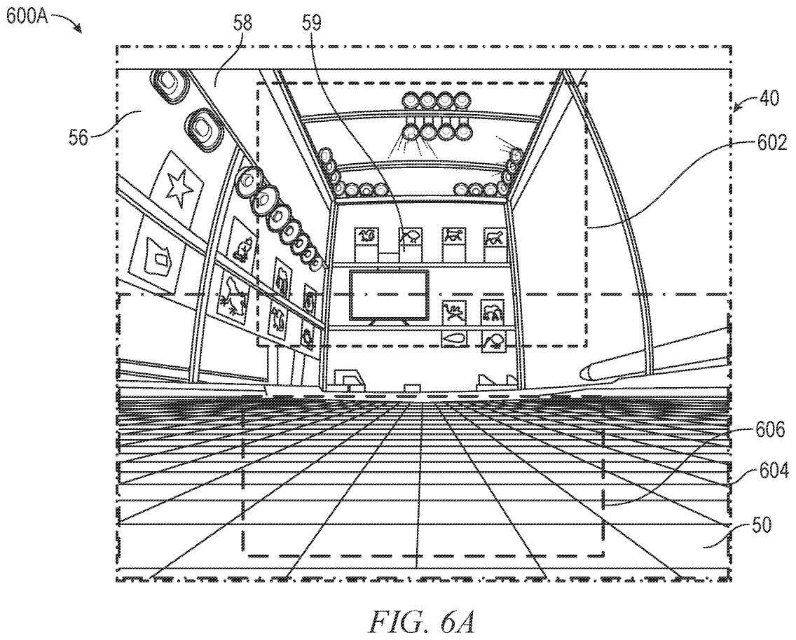

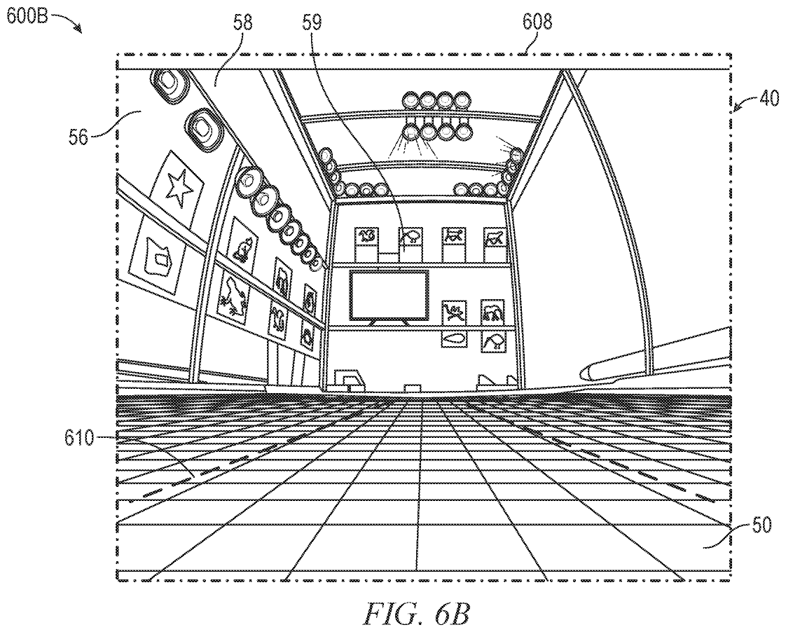

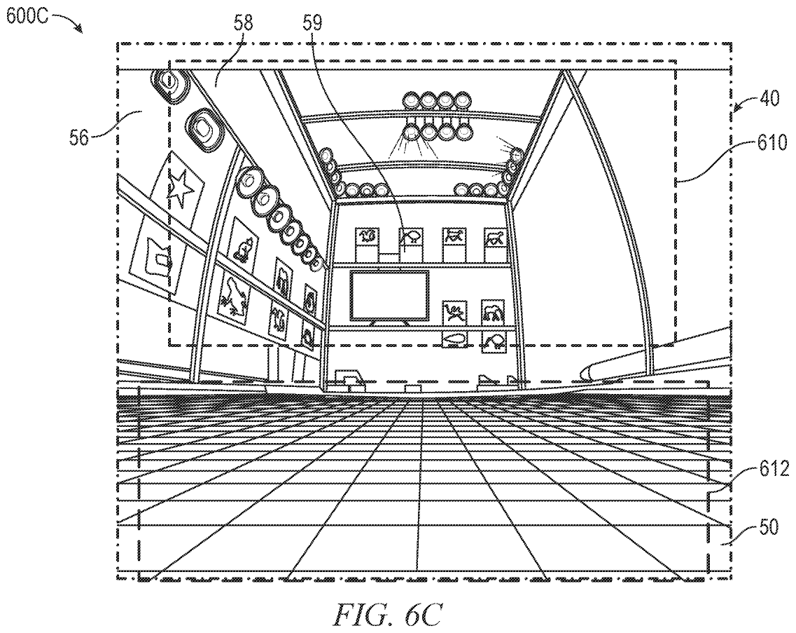

FIG. 6A illustrates a frame 600A captured by a camera of a robot, such as the camera (image capture device) 140 of the robot 100. FIG. 6B illustrates a frame 600B captured by a camera of a robot. FIG. 6C illustrates a frame 600C captured by a camera of a robot. FIGS. 6A-6C are discussed together below.

The frames 600A-600C (collectively referred to as the frames 600) can be based produced by the camera based on an optical field of view by the camera. The frames 600 can be of an environment 40 of the robot 100. The environment 40 can include a floor 50, walls 56, and a ceiling 58. Objects (e.g., pictures) 59 can be located on the floor 50, walls 56, or ceiling 58.

The frames 600 can be used by the processor (e.g., 212 or 442) to analyze the environment and to perform analysis to control operation and movement of the robot such as VO, VSLAM, obstacle detection and obstacle avoidance (ODOA), visual docking, or visual scene understanding (VSU). Using the camera 140 and processor 212 to perform multiple functions requires analysis of different portions of the frame. For example, VSLAM can use a portion 602, visual odometry (VO) analysis can use a portion 604, and ODOA can use a portion 606 of the frame 600A, as shown in FIG. 6A. Meanwhile, VSU and visual docking can use a portion 608.

VSLAM can be used to compare features that are detected from frame to frame in order to build a map of its environment (such as the environment 40) and to localize the robot 100 within the environment 40. VSLAM can analyze the frames for features that are above the horizon, such as in the portion 602, where landmarks are more likely to overlap between frames. On the other hand, ODOA can be used to detect obstacles that lie in the path of the robot, so ODOA analysis can view objects below the horizon and as close to the front of the robot as possible, such as in the portion 604. Similarly, VO analysis uses a view of the portion directly in front of the robot to accurately track robot velocity. VSU and visual docking can use most or all of the frame, because VSU can use an entirety of a scene for understanding and a dock can be located in many locations in an environment.

One challenge to providing useful imagery to a number of applications for simultaneous analysis is setting or selecting the exposure of the camera 140 so that all of the frames are well-exposed for their respective analysis. Some common lighting conditions can cause brightness in a region on the floor in front of the robot 100 to be very different from the brightness in regions above the horizon at a longer distance. For example, rooms that are lit by daylight coming through windows can cause floor areas near the windows to be very bright compared to areas far away from the windows. Also, under low illumination conditions where a front-facing LED on a robot is turned on, the area just in front of the robot can be much brighter than areas further away and higher in the field of view. In order to produce images that are well-exposed for VSLAM, one solutions is for VSLAM exposure to be calculated based on the region of interest for VSLAM only. For images that are well-exposed for ODOA, the exposure can be calculated based on the region of interest for ODOA.

Camera exposure can be determined by analyzing pixel values in a captured image or frame to calculate an average weighted luminance of the image, such as by using a weighting table for the frame. Also, a weighting equation can be used instead of a weighting table, where the equation can be used to apply luminance values to different portions of the frame. The frame luminance can be compared to a target average luminance value, and exposure can be adjusted (the exposure time or gain) so that the average luminance value in the frame matches the target luminance value within a specified tolerance.

In many cases, in order to help ensure that all areas within the image that will be analyzed to extract features have information content, different exposures are required. Different exposures can be used to acquire well-exposed frames for each vision application by applying weighted metering to reflect the region of interest within the image for each application for frames that are used by each application without losing any frames. Auto-exposure control systems can perform such a task of changing exposure.

However, while some auto-exposure control systems allow for the exposure weighting tables to be changed (such as between frames) for calculating exposure, there is a limit on the amount that the exposure can be changed from frame to frame before flickering occurs (where flickering can be induced by rapid transient changes in the scene that can be caused by camera or subject motion). The net effect is that a significant number of frames can be required to settle on the correct exposure when changing the weighting table between frames. For vision applications where the frames need to be analyzed to control the motion and path of the robot 100 with critical time constraints, waiting several frames can be undesirable. The methods below help to address these issues.

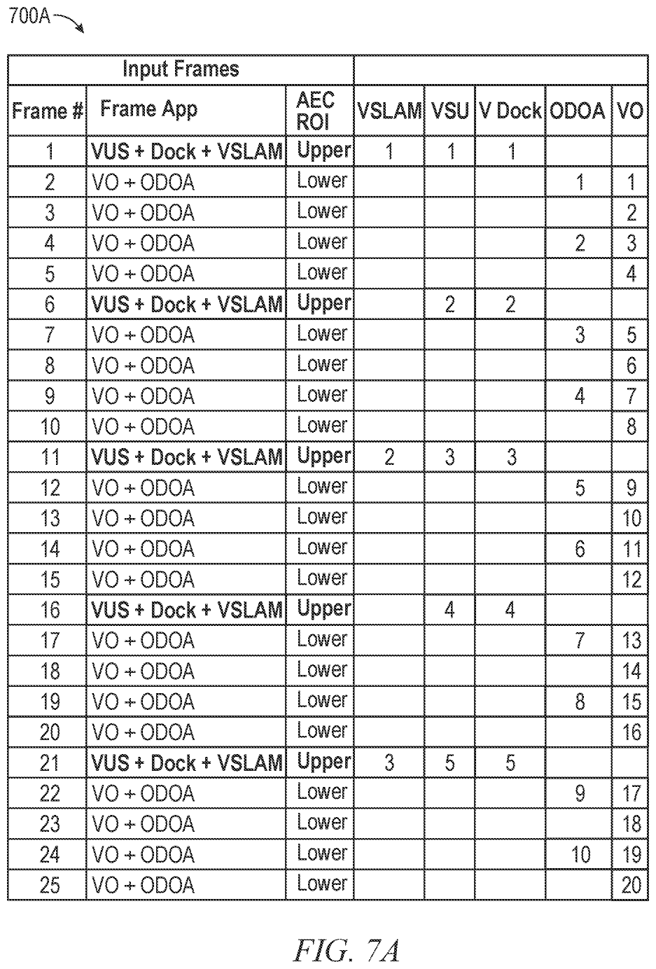

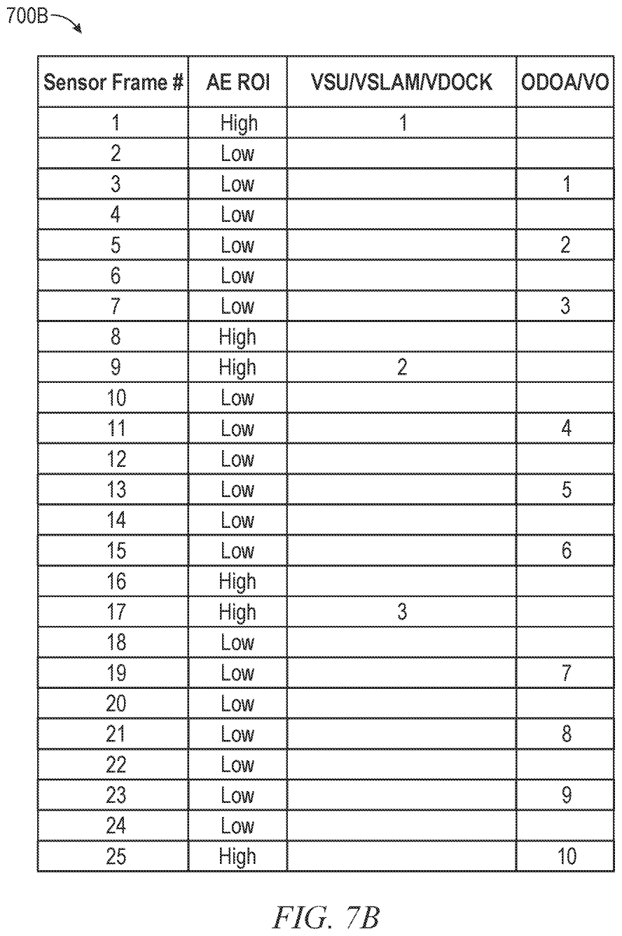

As shown in FIG. 6C, the frames can be analyzed using two regions of interest, AE1 610 and AE2 612 where AE1 is an upper region and AE2 is a lower region. A frame sequence, as shown in FIG. 7A can require 1 frame exposed using AE1 followed by 4 frames exposed using AE2. That is, 4 frames can be taken with the exposure set for the lower region of interest (ROI) (AE2) followed by 1 frame with the exposure set for the higher ROI (AE1). In cases where the difference in the luminance between the two ROIs is high, a number of frames can be used to adjust the exposure to match the exposure target after changing the weighting tables, which can result in a number of frames that may not be well-exposed and result in failure of the vision applications to function. As discussed with respect to the flow charts below, latency between changing exposure (or weighting) tables can be achieved by adding an exposure control task (or method or program) that creates and monitors weighted average luminance values in both regions of interest (AE1 and AE2) simultaneously where one ROI can be designated as the leader and the other as the follower.

More specifically, as shown in FIG. 7A, in the first frame (Frame #1), applications, for VSU, Visual docking, and VSLAM can be run using the AE1 ROI where exposure is set based on this region while exposure can be monitored for AE2 ROI. Then, in frames 2 through 5, the exposure can be set based on AE2 ROI and ODOA and VO can be run based on frames 2 through 5 collected at this exposure while exposure can be monitored for AE1 ROI in frames 2 through 5. Then, the exposure can be set for the AE1 ROI at frame 5 and VSU and visual docking applications can be run. Such a sequence and exposure control can help to minimize image flickering, which can help to reduce a quantity of unusable frames.

FIG. 7A also shows how the frame rates for different applications or analyses can vary. For example, VSLAM is shown as having a frame rate of 3 frames per 25 (or 3 frames per second (FPS)), VSU can have a frame rate of 5 FPS, visual docking can have a frame rate of 5 FPS, ODOA can have a frame rate of 10 FPS, and VO can have a frame rate of 20 FPS. Selectively reducing the frame rates for various applications can help to save processing power. Though these particular frames are shown, other frame rates can be used, such as 1, 2, 5, 10, 15, 20, 25, 30, or the like.

FIG. 7B illustrates a frame sequencing table of a second method that can be used to reduce latency between changing exposure tables. Similarly to the sequence shown in FIG. 7A, the exposure can be adjusted between frames where applications are changed, but in the sequence of FIG. 7B a blank or initializing frame can be taken at every other frame for exposure settling to help reduce flickering caused by exposure changes between frames.

FIG. 8A illustrates a flow chart 800A of a method 800 of operating a mobile cleaning robot. FIG. 8B illustrates a flow chart 800B of the method 800 of operating a mobile cleaning robot. FIG. 8C illustrates a flow chart 800C of the method 800 of operating a mobile cleaning robot. FIGS. 8A-8C are discussed together below.

The method 800 can include a step of producing, using a front-facing camera of the robot, an imaging output based on an optical field of view of the front-facing camera, where the imaging output includes a first frame and a second frame. An upper portion of the imaging output and a lower portion of the imaging output can be monitored and an exposure time of the front-facing camera can be adjusted based on the upper portion of the imaging output of view and the lower portion of the imaging output. Though the methods below are discussed with respect to a particular region, such as an upper and a lower region. The regions can be portions in any particular portion of the image, including overlapping portions. In some examples, the portions can be divided by a horizon. Also, the portions can be a first portion and a second portion. For example, the upper portion can be a first portion and the lower portion can be a second portion. Optionally, additional portions can be analyzed, such as a third portion, fourth portion, or the like.

The steps or operations of the method 800 are illustrated in a particular order for convenience and clarity; many of the discussed operations can be performed in a different sequence or in parallel without materially impacting other operations. The method 800 as discussed includes operations performed by multiple different actors, devices, and/or systems. It is understood that subsets of the operations discussed in the method 800 can be attributable to a single actor, device, or system could be considered a separate standalone process or method.

At step 802 of the method 800, a maximum exposure time Tmax can be set and at step 804 a max gain Gmax can be set. At step 806 an exposure target average luminance can be set and at step 808 an exposure target tolerance Tol can be set. At step 810 a leader exposure weighting table can be loaded and at step 812 a follower exposure weighting table can be loaded. At step 814, a frame sequence can be specified. For example, the frame sequence shown in FIG. 7A can be specified. At step 816 the frame ID can be set before a frame is captured at step 818 (as shown in the method 808B of the method 800 in FIG. 8B).

The frame (such as the frame 600A) can be captured by the camera 140 of the robot 100 for analysis on the frame, such as for VSLAM, VO, ODOA, etc. Once the frame is captured, the average weighted luminance of the follower region (e.g., AE2) can be calculated using the frame and the follower exposure weighting table at step 820. Similarly, the average weighted luminance of the leader region (e.g., AE1) can be calculated using the frame and the leader exposure weighting table at step 822.

Once the average luminance values are calculated, it can be determined whether the leader ROI luminance value is greater to or equal than the target luminance plus the tolerance (e.g., the target set at step 806 and tolerance set at step 808) at step 824. When it is determined that the leader ROI luminance value is greater than to or equal than the target luminance plus the tolerance, the exposure setting (e.g., gain or exposure time) can be reduced at step 826 before the next frame is captured. When the leader ROI luminance value is not greater than to or equal than the target luminance plus the tolerance, step 828 can be performed where it can be determined whether the leader ROI luminance value is less than to or equal than the target luminance minus the tolerance. When it is determined that the leader ROI luminance value is less than to or equal to the target luminance minus the tolerance, the exposure setting (e.g., gain or exposure time) can be increased at step 830 before the next frame is captured. When the leader ROI luminance value is not less than or equal to the target luminance minus the tolerance, it can be determined whether the frame is currently the leader frame (e.g., AE1) at step 832. When the frame is the leader frame, the exposure adjustment for the current frame can be considered complete and the next frame can be captured.

When the frame ID is not the leader (e.g., AE2), the method can continue at method 800C as shown in FIG. 8C, where the average weighted luminance of the leader ROI can be compared to the weighted luminance of the follower ROI to determine if the follower ROI is exposed within tolerance, underexposed, or overexposed. At step 834 it can be determined whether the leader ROI luminance minus the tolerance is less than or equal to the follower ROI luminance and whether the follower ROI luminance is less than or equal to the leader ROI luminance. If so, the follower exposure time (tfollower) can be set to equal the leader exposure time (tleader) at step 836 before the next frame is captured at step 850 (continuing the loop of the method 800). If not, step 838 can be performed where it can be determined the leader ROI luminance divided by the follower ROI luminance is less than the max exposure time divided by the leader exposure time. If so, the follower exposure time can be updated at step 840 where the follower exposure time (tfollower) can be set to the leader exposure time (tleader) times the leader ROI luminance divided by the follower ROI luminance. If not, the follower exposure time can be set to the max exposure time at step 842 and the follower gain (Gfollower) can be set to the leader ROI luminance divided by the follower ROI luminance, this ratio can be multiplied by the ratio of the max exposure time divided by the leader exposure time at step 844.

Thereafter, at step 846 it can be determined if the follower gain (Gfollower) is greater than the maximum gain (Gmax). If not, the next frame can be captured at step 850. If so, the follower gain (Gfollower) can be set to be the max gain (Gmax) and the next frame can be captured at step 850.

The method 800 can allow the exposure setting(s) to be updated based on each frame captured for the leader ROI or the follower ROI so that when the next or following frame is captured, it will be exposed such that analysis can be performed on the image for various applications or calculations. The method 800 can be a loop or application that can be run for each frame, though the initialization steps of the portion 800A can be skipped following capture of the first frame, such that the portions 800B and 800C can be repeated for each frame captured while the camera 140 of the robot 100 is operating and producing an image stream. Also, though exposure time changes are discussed in detail, the other image capture parameters of the image can be similarly adjusted (up and down) based on luminance calculations. For example, image gain can be similarly adjusted based on calculated luminance values.

The frames captured using the method 800 can be used to perform various types of analysis discussed above. For example, AE1 or an upper portion of the frame can be used to perform VSLAM analysis with respect to an environment. Similarly, AE1 or a lower portion of the frame can be used to perform ODOA or VO analysis with respect to an environment. Such analysis can be used by the controller 112 to control a motor to drive one or more wheels of the robot 100 to avoid an obstacle detected within the environment 40 based on a detected obstacle, based on the location of the robot with respect to the environment, and based on the map of the environment.

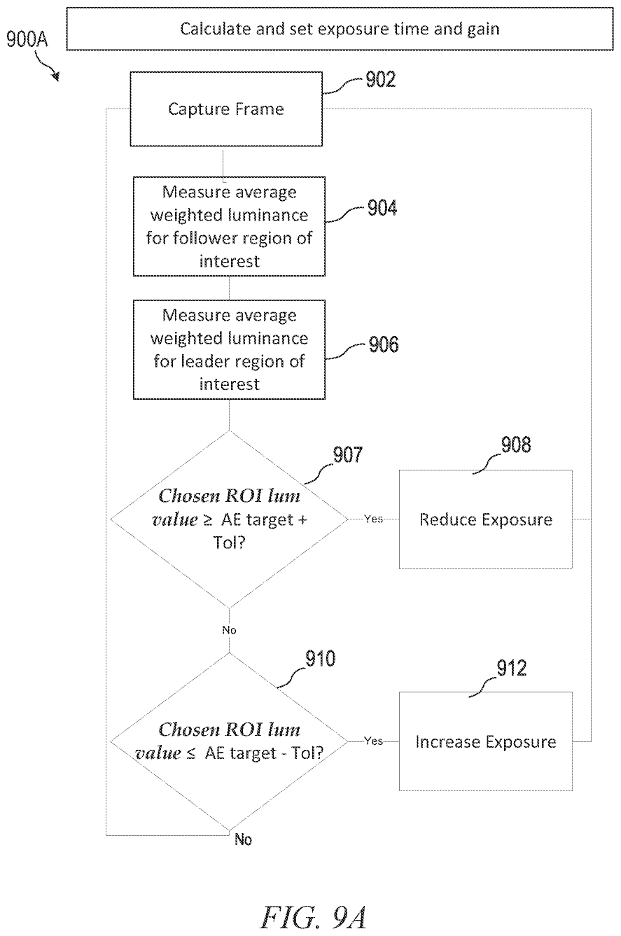

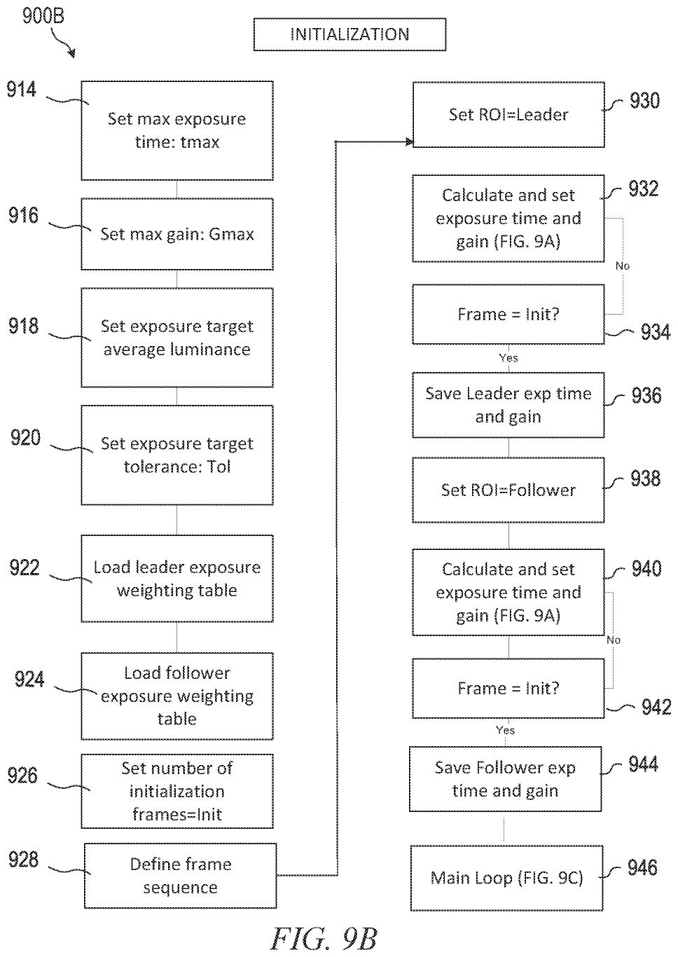

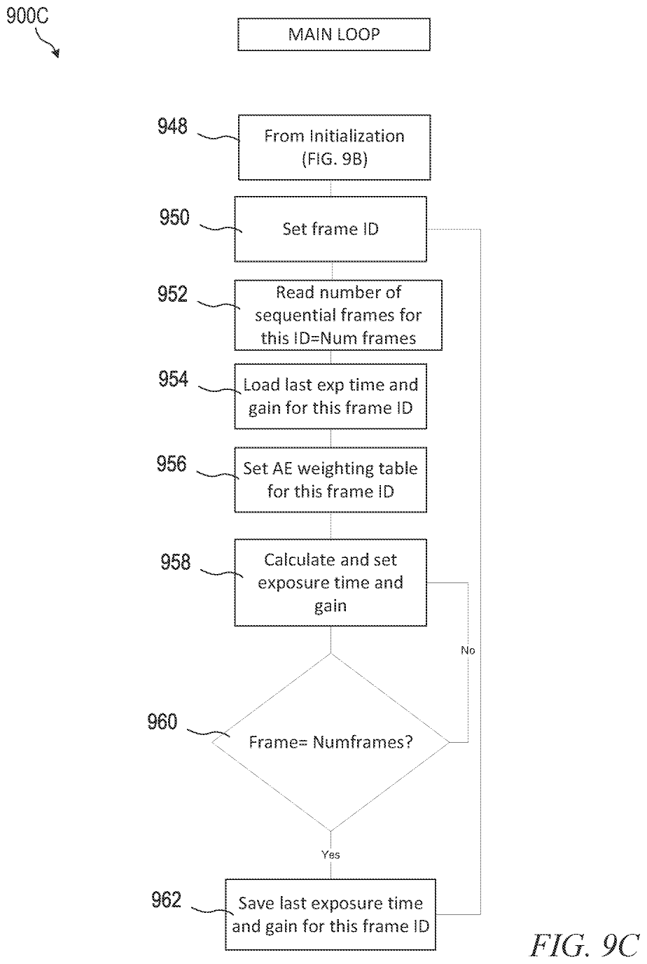

FIG. 9A illustrates a flow chart 900A of operating a mobile cleaning robot. FIG. 9B illustrates a flow chart 900B of operating a mobile cleaning robot. FIG. 9C illustrates a flow chart 900C of operating a mobile cleaning robot.

The method 900 can include a step of producing, using a front-facing camera of the robot, an imaging output based on an optical field of view of the front-facing camera, where the imaging output includes a first frame and a second frame. An upper portion of the imaging output and a lower portion of the imaging output can be monitored and an exposure time of the front-facing camera can be adjusted based on the upper portion of the imaging output of view and the lower portion of the imaging output. The steps or operations of the method 900 are illustrated in a particular order for convenience and clarity; many of the discussed operations can be performed in a different sequence or in parallel without materially impacting other operations. The method 900 as discussed includes operations performed by multiple different actors, devices, and/or systems. It is understood that subsets of the operations discussed in the method 900 can be attributable to a single actor, device, or system could be considered a separate standalone process or method.

More specifically, using a sequencing table such as the table of FIG. 7B, exposure can be controlled using an initializing frame spaced between each analyzed frame. At step 902, a frame can be captured (such as the frame 600C) can be captured by the camera 140 of the robot 100 for analysis on the frame, such as for VSLAM, VO, ODOA, etc. Once the frame is captured, the average weighted luminance of the follower region (e.g., AE2) can be calculated using the frame and the follower exposure weighting table at step 904. Similarly, the average weighted luminance of the leader region (e.g., AE1) can be calculated using the frame and the leader exposure weighting table at step 906.

Once the average luminance values are calculated, it can be determined whether the leader ROI luminance value is greater to or equal than the target luminance plus the tolerance (e.g., the target set at step 918 and tolerance set at step 920) at step 907. When it is determined that the chosen (e.g., leader or follower) ROI luminance value is greater than to or equal than the target luminance plus the tolerance, the exposure setting (e.g., gain or exposure time) can be reduced at step 908 before the next frame is captured. When the chosen (e.g., leader or follower) ROI luminance value is not greater than to or equal than the target luminance plus the tolerance, step 910 can be performed where it can be determined whether the chosen (e.g., leader or follower) ROI luminance value is less than to or equal than the target luminance minus the tolerance. When it is determined that the chosen (e.g., leader or follower) ROI luminance value is less than to or equal to the target luminance minus the tolerance, the exposure setting (e.g., gain or exposure time) can be increased at step 912 before the next frame is captured. When the leader ROI luminance value is not less than to or equal to the target luminance minus the tolerance, the next frame can be captured at the step 902. Such a loop can be repeated for each frame and can be used throughout the method 900 as discussed below.

Prior to calculating and setting the image capture parameter, such as gain or exposure (method portion 900A of FIG. 9A), the initialization portion of the method 900B can be performed, as shown in FIG. 9B. At initialization, initial set points and definitions can be set. At step 914, the max exposure time (tmax) can be set and at step 916 a max gain (Gmax) can be set. At step 918 an exposure target average luminance can be set and its tolerance (Tol) can be set at step 920. At step 922 a leader exposure weighting table can be set and at step 924 a follower exposure weighting table can be set. At step 926 a number or quantity of initialization frames can be set. For example, one (1) initialization frame can be used between each leader and follower frame, as shown in the table 700B of FIG. 7B. At step 928 a frame sequence can be set. For example, the sequence shown in the table 700B of FIG. 7B. The frame sequence can include one or more frame rates. For example, the sequence can include a leader frame rate associated with a leader ROI, a follower frame rate associated with a follower ROI, and an initialization frame rate, where an initialization frame is captured between the leader frames and the follower frame or between each non-initialization frame.

At step 930 the ROI can be set to be leader and the exposure time and gain can be calculated and set at step 932 using the method portion 900A of FIG. 9A. Once the leader exposure time and gain are set it can be determined (such as based on the frame sequence) whether the frame is an initialization frame at step 934. If the frame is not an initialization frame, step 932 can be performed again where another frame can be captured and the exposure time and gain can be adjusted or set again. If the frame is an initialization frame, the leader exposure time and gain can be saved at step 936 and the ROI can be set to the follower ROI at the step 938.

Then, the exposure time and gain can be calculated and set at step 932 using the method portion 900A of FIG. 9A, but using the follower parameters (e.g., follower exposure weighting table). Once the follower exposure time and gain are set it can be determined (such as based on the frame sequence) whether the frame is an initialization frame at step 942. If the frame is not an initialization frame, step 940 can be performed again where another frame can be captured and the exposure time and gain can be adjusted or set again. If the frame is an initialization frame, the follower exposure time and gain can be saved at step 944 and the method can continue at the method portion 900C (the main loop) where the initialization loop can be complete.

In the main loop, shown as the method portion 900C of the method 900 of FIG. 9C, the method can be continued at step 948 from initialization and the frame ID can be set at the step 950. A number of sequential frames for the ID can be read (such as from a sequencing table) and can be set. For example, there can be 1, 2, 3, 4, 5, 10, or the like sequential frames for a given frame ID. Then, at step 954, the most recent exposure time and gain can be loaded for the frame ID (e.g., the exposure time and gain for the leader ID), which can be calculated and set in the method portion 900A. The weighting table for the frame ID (e.g., the leader exposure weighting table) can be loaded at step 956. Once the parameters are set, the exposure time and gain can be calculated at step 958, which can be the method portion 900A. Once the exposure time and gain are set for the frame (such as by using the method portion 900A), it can be determined whether the current frame number equals the number of frames for the frame ID at step 960, if not, the step 958 can be repeated. If so, the exposure time and gain can be set for the frame ID and a new frame ID can be set at 962 (such as according to the frame sequence).

The method 900 can allow the image capture setting(s) to be updated based on each frame captured for the leader ROI or the follower ROI so that when the next or following frame is captured, it will be exposed such that analysis can be performed on the image for various applications or calculations. The method 900 can be a loop or application that can be run for each frame, though the initialization can be optionally skipped following capture of the first frame, such that the portions 900A and 900C can be repeated for each frame captured while the camera 140 of the robot 100 is operating and producing an image stream.

The frames captured using the method 900 can be used to perform various types of analysis discussed above, such as VSLAM, ODOA, VO, VSU, or the like, where the methods can help these processes to be performed with the loss of fewer frames for settling (reducing flickering) helping to improve performance of these processes.

### Notes and Examples

The following, non-limiting examples, detail certain aspects of the present subject matter to solve the challenges and provide the benefits discussed herein, among others.

Example 1 is a method of operating an autonomous mobile cleaning robot using image processing, the method comprising: producing, using a front-facing camera of the robot, an imaging output based on an optical field of view of the front-facing camera, the imaging output including a first frame and a second frame; monitoring an upper portion of the imaging output and a lower portion of the imaging output; and adjusting an image capture parameter of the front-facing camera based on the upper portion of the imaging output and the lower portion of the imaging output.

In Example 2, the subject matter of Example 1 optionally includes performing at least one of visual simultaneous location analysis or mapping analysis with respect to an environment based at least in part on the imaging output using the upper portion in the first frame.

In Example 3, the subject matter of Example 2 optionally includes performing at least one of obstacle detection or obstacle avoidance analysis with respect to the environment based at least in part on the imaging output using the lower portion in the second frame.

In Example 4, the subject matter of Example 3 optionally includes performing visual odometry analysis with respect to the environment based at least in part on the imaging output using the lower portion in the second frame.

In Example 5, the subject matter of Example 4 optionally includes producing or updating a map of the environment based on the imaging output using the first frame; and controlling the robot to avoid an obstacle detected within the environment based on at least one of the detected obstacle, the location of the robot with respect to the environment, or the map of the environment.

In Example 6, the subject matter of any one or more of Examples 1-5 optionally include wherein a first frame rate of the imaging output using the upper portion is lower than a second frame rate of the imaging output using the lower portion.

In Example 7, the subject matter of any one or more of Examples 1-6 optionally include wherein a sequence of frames includes a first type including the first frame and includes a second type including the second frame, the first frame of the first type separated by at least two frames of the second type.

In Example 8, the subject matter of Example 7 optionally includes wherein a first resolution of the first frame is higher than a second resolution of the second frame.

In Example 9, the subject matter of any one or more of Examples 1-8 optionally include determining a luminance characterizing the upper portion based on a lead exposure weighting table; and determining a luminance characterizing the lower portion based on a follower exposure weighting table.

In Example 10, the subject matter of Example 9 optionally includes reducing the image capture parameter when the average luminance of the upper portion is greater than or equal to a target luminance for the upper portion; and increasing the image capture parameter when the average luminance of the upper portion is less than or equal to a target luminance for the upper portion.

Example 11 is a method of operating an autonomous mobile cleaning robot using image processing, the method comprising: producing, using a front-facing camera of the robot, an imaging output based on an optical field of view of the front-facing camera; monitoring a lead portion of the imaging output and a follower portion of imaging output; and adjusting an image capture parameter of the front-facing camera based on the lead portion and the follower portion.

In Example 12, the subject matter of Example 11 optionally includes defining a frame sequence including a lead frame rate associated with the lead portion, a follower frame rate associated with the follower portion, and an initialization frame rate, where an initialization frame is captured between a lead frame and a follower frame.

In Example 13, the subject matter of Example 12 optionally includes setting a region of interest of the imaging output to the lead portion; and adjusting, when the region of interest is the lead portion, a lead image capture parameter by: determining a luminance characterizing the lead portion based on a lead exposure weighting table; measuring an average luminance of the follower portion based on a follower exposure weighting table; reducing the lead image capture parameter when the average luminance of the lead portion is greater than or equal to a target luminance for the lead portion; and increasing the lead image capture parameter when the average luminance of the lead portion is less than or equal to the target luminance for the lead portion.

In Example 14, the subject matter of Example 13 optionally includes setting a region of interest of the imaging output to the follower portion; and adjusting, when the region of interest is the follower portion, a follower image capture parameter by: measuring an average luminance of the lead portion based on a lead exposure weighting table; measuring an average luminance of the follower portion based on a follower exposure weighting table; reducing the follower image capture parameter when the average luminance of the follower portion is greater than or equal to a target luminance for the follower portion; and increasing the follower image capture parameter when the average luminance of the follower portion is less than or equal to the target luminance for the follower portion.

In Example 15, the subject matter of Example 14 optionally includes setting a frame identification; determining a number of frames based on the frame sequence and the frame identification; loading the lead image capture parameter when the frame identification is a lead frame; and loading the follower image capture parameter when the frame identification is a follower frame.

In Example 16, the subject matter of Example 15 optionally includes loading the follower exposure weighting table when the frame identification is a lead frame; and loading the lead exposure weighting table when the frame identification is a follower frame.

In Example 17, the subject matter of Example 16 optionally includes readjusting, when the frame identification is the lead frame, the lead image capture parameter; and readjusting, when the frame identification is the follower frame, the follower image capture parameter.

In Example 18, the subject matter of any one or more of Examples 11-17 optionally include wherein one of the lead portion and the follower portion of the imaging output is an upper portion of the imaging output and wherein the other of the lead portion and the follower portion of the imaging output is a lower portion of the imaging output.

In Example 19, the subject matter of Example 18 optionally includes performing visual simultaneous location and mapping analysis with respect to an environment based on the imaging output using the upper portion.

In Example 20, the subject matter of Example 19 optionally includes performing obstacle detection and obstacle avoidance analysis with respect to the environment based on the imaging output using the lower portion.

In Example 21, the subject matter of Example 20 optionally includes performing visual odometry analysis with respect to the environment based on the imaging output using the lower portion.

In Example 22, the subject matter of Example 21 optionally includes wherein the image capture parameter is exposure time or gain.

Example 23 is a method of operating an autonomous mobile cleaning robot using image processing, the method comprising: producing, using a front-facing camera of the robot, an imaging output based on an optical field of view of the front-facing camera, the imaging output; monitoring a first portion of the imaging output and a second portion of the imaging output; and adjusting an image capture parameter of the front-facing camera based on the first portion of the imaging output and the second portion of the imaging output.

In Example 24, the apparatuses, systems, or methods of any one or any combination of Examples 1-23 can optionally be configured such that all elements or options recited are available to use or select from.

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim.

The above description is intended to be illustrative, and not restrictive. For example, the above-described examples (or one or more aspects thereof) can be used in combination with each other. Other embodiments can be used, such as by one of ordinary skill in the art upon reviewing the above description. The Abstract is provided to comply with 37 C.F.R. § 1.72(b), to allow the reader to quickly ascertain the nature of the technical disclosure. It is submitted with the understanding that it will not be used to interpret or limit the scope or meaning of the claims. Also, in the above Detailed Description, various features can be grouped together to streamline the disclosure. This should not be interpreted as intending that an unclaimed disclosed feature is essential to any claim. Rather, inventive subject matter can lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

1. A method of operating an autonomous mobile cleaning robot using image processing, the method comprising:
producing, using a front-facing camera of the robot, an imaging output based on an optical field of view of the front-facing camera, the imaging output including a first frame and a second frame;
monitoring an upper portion of the imaging output and a lower portion of the imaging output; and
adjusting an image capture parameter of the front-facing camera based on the upper portion of the imaging output and the lower portion of the imaging output.

2. The method of claim 1, further comprising:
performing at least one of visual simultaneous location analysis or mapping analysis with respect to an environment based at least in part on the imaging output using the upper portion in the first frame.

3. The method of claim 2, further comprising:
performing at least one of obstacle detection or obstacle avoidance analysis with respect to the environment based at least in part on the imaging output using the lower portion in the second frame.

4. The method of claim 3, further comprising:
performing visual odometry analysis with respect to the environment based at least in part on the imaging output using the lower portion in the second frame.

5. The method of claim 4, further comprising:
producing or updating a map of the environment based on the imaging output using the first frame; and
controlling the robot to avoid an obstacle detected within the environment based on at least one of the detected obstacle, the location of the robot with respect to the environment, or the map of the environment.

6. The method of claim 1, wherein a first frame rate of the imaging output using the upper portion is lower than a second frame rate of the imaging output using the lower portion.

7. The method of claim 1, wherein a sequence of frames includes a first type including the first frame and includes a second type including the second frame, the first frame of the first type separated by at least two frames of the second type.

8. The method of claim 7, wherein a first resolution of the first frame is higher than a second resolution of the second frame.

9. The method of claim 1, further comprising:
determining a luminance characterizing the upper portion based on a lead exposure weighting table; and
determining a luminance characterizing the lower portion based on a follower exposure weighting table.

10. The method of claim 9, further comprising:
reducing the image capture parameter when the average luminance of the upper portion is greater than or equal to a target luminance for the upper portion; and
increasing the image capture parameter when the average luminance of the upper portion is less than or equal to a target luminance for the upper portion.

11. A method of operating an autonomous mobile cleaning robot using image processing, the method comprising:
producing, using a front-facing camera of the robot, an imaging output based on an optical field of view of the front-facing camera;
monitoring a lead portion of the imaging output and a follower portion of imaging output; and
adjusting an image capture parameter of the front-facing camera based on the lead portion and the follower portion.

12. The method of claim 11, further comprising:
defining a frame sequence including a lead frame rate associated with the lead portion, a follower frame rate associated with the follower portion, and an initialization frame rate, where an initialization frame is captured between a lead frame and a follower frame.

13. The method of claim 12, further comprising:
setting a region of interest of the imaging output to the lead portion; and
adjusting, when the region of interest is the lead portion, a lead image capture parameter by:
determining a luminance characterizing the lead portion based on a lead exposure weighting table;
measuring an average luminance of the follower portion based on a follower exposure weighting table;
reducing the lead image capture parameter when the average luminance of the lead portion is greater than or equal to a target luminance for the lead portion; and
increasing the lead image capture parameter when the average luminance of the lead portion is less than or equal to the target luminance for the lead portion.

14. The method of claim 13, further comprising:
setting a region of interest of the imaging output to the follower portion; and
adjusting, when the region of interest is the follower portion, a follower image capture parameter by:
measuring an average luminance of the lead portion based on a lead exposure weighting table;
measuring an average luminance of the follower portion based on a follower exposure weighting table;
reducing the follower image capture parameter when the average luminance of the follower portion is greater than or equal to a target luminance for the follower portion; and
increasing the follower image capture parameter when the average luminance of the follower portion is less than or equal to the target luminance for the follower portion.

15. The method of claim 14, further comprising:
setting a frame identification;
determining a number of frames based on the frame sequence and the frame identification;
loading the lead image capture parameter when the frame identification is a lead frame; and
loading the follower image capture parameter when the frame identification is a follower frame.

16. The method of claim 15, further comprising:
loading the follower exposure weighting table when the frame identification is a lead frame; and
loading the lead exposure weighting table when the frame identification is a follower frame.

17. The method of claim 16, further comprising:
readjusting, when the frame identification is the lead frame, the lead image capture parameter; and
readjusting, when the frame identification is the follower frame, the follower image capture parameter.

18. The method of claim 11, wherein one of the lead portion and the follower portion of the imaging output is an upper portion of the imaging output and wherein the other of the lead portion and the follower portion of the imaging output is a lower portion of the imaging output.

19. The method of claim 18, further comprising:
performing visual simultaneous location and mapping analysis with respect to an environment based on the imaging output using the upper portion.

20. The method of claim 19, further comprising:
performing obstacle detection and obstacle avoidance analysis with respect to the environment based on the imaging output using the lower portion.
